(19) United States
(12) Patent Application Publication
(10) Pub. No.: US 2022/0086461 A1
(43) Pub. Date: Mar. 17, 2022

(54) IMAGE ENCODING/DECODING METHOD AND APPARATUS

(71) Applicant: INDUSTRY ACADEMY COOPERATION FOUNDATION OF SEJONG UNIVERSITY, Seoul (KR)

(72) Inventors: Yung Lyul LEE, Seoul (KR); Nam Uk KIM, Seoul (KR); Myung Jun KIM, Seoul (KR); Ji Yeon JUNG, Seoul (KR); Yang Woo KIM, Seoul (KR)

(73) Assignee: INDUSTRY ACADEMY COOPERATION FOUNDATION OF SEJONG UNIVERSITY, Seoul (KR)

(21) Appl. No.: 17/420,478

(22) PCT Filed: Jan. 7, 2020
(86) PCT No.: PCT/KR2020/000288

§ 371 Date: Jul. 2, 2021

(30) Foreign Application Priority Data
Jan. 10, 2019 (KR) 10-2019-0003542

(51) Int. Cl. H04N 19/159; H04N 19/105; H04N 19/46; H04N 19/176

(52) U.S. Cl. CPC H04N 19/159; H04N 19/176; H04N 19/46; H04N 19/105

(57) ABSTRACT

Disclosed herein is an image decoding method. The image decoding method according to an embodiment of the present invention includes determining a prediction mode of a current block based on at least one of sizes of the current block and generating a prediction block of the current block based on the determined prediction mode. Herein, the determining of the prediction mode of the current block determines the prediction mode of the current block based on a comparison result between the size of the current block and a preset value.

### TECHNICAL FIELD

The present invention relates to an image encoding/decoding method and apparatus and, more particularly, to an encoding/decoding method of prediction mode information.

### BACKGROUND ART

Recently, the demand for multimedia data such as video is rapidly increasing on the Internet. However, the pace of advancement in the bandwidth of a channel hardly follows the amount of multimedia data on a rapid increase. Considering this situation, the Video Coding Expert Group (VCEG) of ITU-T and the Moving Picture Expert Group (MPEG) of ISO/IEC, which are international standardization organizations, established the High Efficiency Video Coding (HEVC) Version 1, which is a video compression standard, in February 2014.

As for video compression techniques, there are various techniques like intra prediction, inter prediction, transform, quantization, entropy encoding, and in-loop filter. The conventional image encoding/decoding method encodes/decodes prediction mode information, which indicates a prediction mode, in every unit, and thus has a limitation in improving coding efficiency.

### DISCLOSURE

### Technical Problem

In order to solve the problem described above, the present invention aims mainly to provide an encoding and decoding method of more efficient prediction mode information.

### Technical Solution

An image decoding method according to an embodiment of the present invention may include determining a prediction mode of a current block based on a size of the current block and generating a prediction block of the current block based on the determined prediction mode. Herein, the determining of the prediction mode of the current block may determine the prediction mode of the current block based on a comparison result between the size of the current block and a preset value.

In the image decoding method, when the size of the current block is equal to or less than the preset value, the determining of the prediction mode of the current block may determine the prediction mode of the current block as an intra prediction mode without entropy-decoding of prediction mode information of the current block.

In the image decoding method, when the size of the current block is greater than the preset value, the determining of the prediction mode of the current block may entropy-decode prediction mode information of the current block and determine the prediction mode of the current block according to the entropy-decoded prediction mode information of the current block.

In the image decoding method, when the size of the current block is equal to the preset value, the determining of the prediction mode of the current block may determine the prediction mode of the current block as an intra prediction mode without entropy-decoding of prediction mode information of the current block.

In the image decoding method, the size of the current block may include at least one of a width and a height of the current block.

An image encoding method according to an embodiment of the present invention may include determining a prediction mode of the current block based on a size of the current block and generating a bit stream according to the determination. Herein, the determining of the prediction mode of the current block may determine whether or not to entropy-encode the prediction mode information, based on a comparison result between a size of the current block and a preset value.

In a non-transitory computer readable recording medium storing a bitstream used for image decoding according to an embodiment of the present invention, the bitstream includes prediction mode information of a current block, and in the image decoding, a prediction mode of the current block is determined based on a comparison result between a size of the current block and a preset value. When the size of the current block is equal to or less than the preset value, the prediction mode of the current block may be determined to be an intra prediction mode without entropy-decoding of the prediction mode information of the current block.

### Advantageous Effects

According to the present invention, as the amount of coding information may be reduced, coding efficiency may be improved.

Also, as a context model applied to encoding or decoding of prediction mode information is effectively selected, arithmetic encoding and arithmetic decoding performance may be improved.

### DESCRIPTION OF DRAWINGS

FIG. 1 is a block diagram showing an image encoding apparatus according to an embodiment of the present invention.

FIG. 2 is a block diagram showing an image decoding apparatus according to an embodiment of the present invention.

FIG. 3 is syntax and semantics for describing decoding of prediction mode information.

FIG. 4 is a flowchart showing a method of determining a prediction mode of a current block based on a size of the current block.

FIG. 5 is a flowchart showing a method of determining a prediction mode of a current block based on a size of the current block.

FIG. 6 is a flowchart showing an entropy encoding/decoding method of prediction mode information based on a size of a current block.

FIG. 7 is a flowchart showing an entropy encoding/decoding method of prediction mode information based on a size of a current block.

FIG. 8 is a flowchart showing an entropy encoding/decoding method of prediction mode information based on a size of a current block.

FIG. 9 is a flowchart showing an entropy encoding/decoding method of prediction mode information based on a size of a current block.

FIG. 10 is a flowchart showing a method of determining a prediction mode of a current block based on a distance between a current picture and a reference picture.

FIG. 11 is a flowchart showing a method of determining a prediction mode of a current block based on a distance between a current picture and a reference picture.

FIG. 12 is a flowchart showing an entropy encoding/decoding method of prediction mode information based on a distance between a current picture and a reference picture.

FIG. 13 is a flowchart showing an entropy encoding/decoding method of prediction mode information based on a distance between a current picture and a reference picture.

FIG. 14 is a flowchart showing an entropy encoding/decoding method of prediction mode information based on a distance between a current picture and a reference picture.

FIG. 15 is a flowchart for explaining an image decoding method according to an embodiment of the present invention.

FIG. 16 is a flowchart for explaining an image decoding method according to an embodiment of the present invention.

FIG. 17 is a flowchart for explaining an image encoding method according to an embodiment of the present invention.

FIG. 18 is a flowchart for explaining an image encoding method according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. In describing each view, a similar reference sign is used for a similar component.

Terms like ‘first’, ‘second’, etc. may be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of relevant items or any one of a plurality of relevant terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

The terms used in the present application are merely used to describe particular embodiments, and are not intended to limit the present invention. An expression used in the singular encompasses the expression of the plural, unless it has a clearly different meaning in the context. In the present application, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, embodiments of the present invention will be described in detail with reference to the accompanying drawings. Hereinafter, the same constituent elements in the drawings are denoted by the same reference numerals, and a repeated description of the same elements will be omitted.

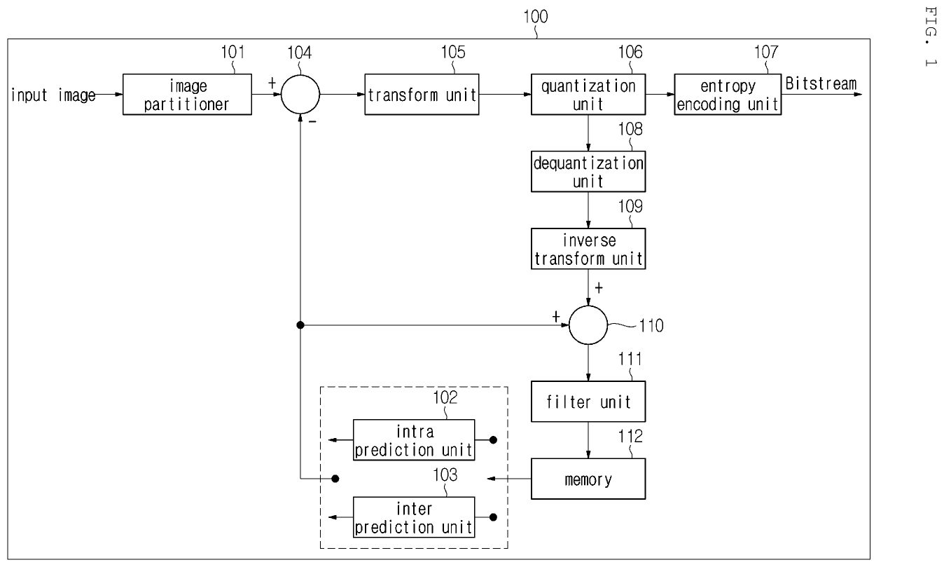

FIG. 1 is a block diagram showing an image encoding apparatus according to an embodiment of the present invention.

Referring to FIG. 1, an image encoding apparatus 100 may include an image partitioner 101, an intra prediction unit 102, an inter prediction unit 103, a subtractor 104, a transform unit 105, a quantization unit 106, an entropy encoding unit 107, a dequantization unit 108, an inverse transform unit 109, an adder 110, a filter unit 111, and a memory 112.

As each constitutional part in FIG. 1 is independently illustrated so as to represent characteristic functions different from each other in an image encoding apparatus, it does not mean that the each constitutional part constitutes separate hardware or a separate constitutional unit of software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

The image partitioner 101 may partition an input image into at least one block. Herein, the input image may have various shapes and sizes such as a picture, a slice, a tile and a segment. A block may mean a coding unit (CU), a prediction unit (PU), or a transform unit (TU). The partitioning may be performed based on at least one of a quad tree, a binary tree, and a ternary tree. The quad tree is a method of dividing an upper block into four quadrant lower blocks so that the width and height of each quadrant are half the width and height of the upper block. The binary tree is a method of dividing an upper block into two lower blocks so that either the width or height of each lower block is half the width or height of the upper block. The ternary tree is a method of dividing an upper block into three lower blocks. For example, the three lower blocks may be obtained by dividing the width or height of the upper block into the ratio of 1:2:1. A block may have a non-square shape as well as a square shape through the above-described binary tree-based partitioning.

The prediction units 102 and 103 may include the inter prediction unit 103 for performing inter prediction and the intra prediction unit 102 for performing intra prediction. It is possible to determine whether to use inter prediction or intra prediction for a prediction unit and to determine specific information (e.g., an intra prediction mode, a motion vector, a reference picture) according to each prediction method. Herein, a processing unit for performing prediction and a processing unit for determining a prediction method and specific content may be different from each other. For example, a prediction method and a prediction mode may be determined in a prediction unit, and prediction may be performed in a transform unit.

A residual value (residual block) between a generated prediction block and an original block may be input into the trans form unit 105. In addition, prediction mode information used for prediction and motion vector information may be encoded together with a residual value in the entropy encoding unit 107 and be transmitted to a decoder. When using a specific encoding mode, an original block may be encoded as it is and be transmitted to a decoding unit without generating a prediction block through the prediction units 102 and 103.

The intra prediction unit 102 may generate a prediction block based on reference pixel information around a current block that is pixel information in a current picture. When a prediction mode of a neighboring block of a current block, on which intra prediction is to be performed, is inter prediction, a reference pixel included in a neighboring block to which inter prediction is applied may be replaced by a reference pixel in another neighboring block to which intra prediction is applied. That is, when a reference pixel is not available, information on the unavailable reference pixel may be replaced by at least one of available reference pixels.

In intra prediction, a prediction mode may have an angular prediction mode that uses reference pixel information according to a prediction direction and a non-angular mode that uses no directional information. A mode for predicting luma information and a mode for predicting chroma information may be different from each other, and information on an intra prediction mode that is used for predicting luma information or information on a predicted luma signal may be utilized to predict chroma information.

The intra prediction unit 102 may include an adaptive intra smoothing (AIS) filter, a reference pixel interpolation unit, and a DC filter. The AIS filter, which is a filter performing filtering on a reference pixel of a current block, may adaptively determine whether or not to apply the filter according to a prediction mode of a current prediction unit. When the prediction mode of the current block is a mode in which AIS filtering is not performed, the AIS filter may not be applied.

The reference pixel interpolation unit of the intra prediction unit 102 may interpolate a reference pixel and thus generate a reference pixel at a position in fractional units, when an intra prediction mode of a prediction unit is a prediction unit in which intra prediction is performed based on a pixel value that is obtained by interpolating the reference pixel. When a prediction mode of a current prediction unit is not a prediction mode that generates a prediction block without interpolating a reference pixel, the reference pixel may not be interpolated. When a prediction mode of a current block is a DC mode, the DC filter may generate a prediction block through filtering.

The inter prediction unit 103 generates a prediction block by using an already reconstructed reference image and motion information that are stored in the memory 112. The motion information may include, for example, a motion vector, a reference picture index, a list 1 prediction flag, and a list 0 prediction flag.

A residual block including residual information, which is a difference between a prediction unit, which is generated in the prediction units 102 and 103, and an original block of the prediction unit, may be generated. The residual block thus generated may be input into the transform unit 130 and be transformed.

The inter prediction unit 103 may derive a prediction block based on information on at least one of a preceding picture and a subsequent picture of a current picture. In addition, a prediction block of a current block may be derived based on information on some encoded regions in the current picture. The inter prediction unit 103 according to an embodiment of the present invention may include a reference picture interpolation unit, a motion prediction unit, and a motion compensation unit.

The reference picture interpolation unit may receive reference picture information from the memory 112 and may generate pixel information on an integer pixel or less from the reference picture. In the case of a luma pixel, an 8-tap DCT-based interpolation filter having different filter coefficients may be used to generate pixel information on an integer pixel or less on a per-¼ pixel basis. In the case of a chroma signal, a 4-tap DCT-based interpolation filter having different filter coefficients may be used to generate pixel information on an integer pixel or less on a per-⅛ pixel basis.

The motion prediction unit may perform motion prediction based on the reference picture interpolated by the reference picture interpolation unit. As methods for calculating a motion vector, various methods, such as a full search-based block matching algorithm (FBMA), a three step search (TSS) algorithm, a new three-step search (NTS) algorithm, and the like may be used. The motion vector may have a motion vector value on a per-½ or -¼ pixel basis on the basis of the interpolated pixel. The motion prediction unit may predict a prediction block of a current block by using different motion prediction methods. As motion prediction methods, various methods, such as a skip method, a merge method, an advanced motion vector prediction (AMVP) method, and the like may be used.

The subtractor 104 generates a residual block of a current block by subtracting a prediction block, which is generated in the intra prediction unit 102 or the inter prediction 103, from a block to be currently encoded.

The transform unit 105 may transform a residual block including residual data by using a transform method like DCT, DST and Karhunen Loeve Transform (KLT). Herein, the transform method may be determined based on an intra prediction mode of a prediction unit that is used to generate a residual block. For example, according to the intra prediction mode, DCT may be used in the horizontal direction and DST may be used in the vertical direction.

The quantization unit 106 may quantize values that are transformed into a frequency domain by the transform unit 105. A quantization coefficient may vary according to a block or according to the importance of an image. A value calculated by the quantization unit 106 may be provided to the dequantization unit 108 and the entropy encoding unit 107.

The transform unit 105 and/or the quantization unit 106 may be selectively included in the image encoding apparatus 100. That is, the image encoding apparatus 100 may encode the residual block by performing at least one of transform and quantization for the residual data of the residual block, or by skipping both transform and quantization. Even though the image encoding apparatus 100 does not perform either one of transform and quantization or does not perform both transform and quantization, a block that is input into the entropy encoding unit 107 is conventionally referred to as a transform block. The entropy encoding unit 107 entropy encodes input data. Entropy encoding may use various encoding methods, for example, exponential Golomb, context-adaptive variable length coding (CAVLC), and context-adaptive binary arithmetic coding (CABAC).

The entropy encoding unit 107 may encode a variety of information, such as coefficient information of a transform block, block type information, prediction mode information, partition unit information, prediction unit information, transmission unit information, motion vector information, reference frame information, interpolation information of a block, and filtering information. Coefficients of a transform block may be encoded on a per-sub-block basis in the transform block.

For encoding of a coefficient of a transform block, various syntax elements may be encoded like Last_sig, which is a syntax element for indicating a position of a first non-zero coefficient in an inverse scan order, Coded_sub_blk_flag, which is a flag for indicating whether or not there is at least one non-zero coefficient in a sub-block, Sig_coeff_flag, which is a flag for indicating whether a coefficient is a non-zero coefficient or not, Abs_greater1_flag, which is a flag for indicating whether or not the absolute value of a coefficient is greater than 1, Abs_greater2_flag, which is a flag for indicating whether or not the absolute value of a coefficient is greater than 2, and Sign_flag that is a flag for signifying a sign of a coefficient. A residual value of a coefficient that is not encoded through the syntax elements may be encoded through the syntax element remaining_coeff.

The dequantization unit 108 dequantizes values that are quantized in the quantization unit 106, and the inverse transform unit 109 inverse-transforms values that are transformed in the transform unit 105. A residual value generated by the dequantization unit 108 and the inverse transform unit 109 may be combined with a prediction unit, which is predicted through a motion estimation unit, a motion compensation unit and the intra prediction unit 102 included in the prediction units 102 and 103, thereby generating a reconstructed block. The adder 110 generates the reconstructed block by adding a prediction block, which is generated by the prediction units 102 and 103, and a residual block generated by the inverse transform unit 109.

The filter unit 111 may include at least one of a deblocking filter, an offset correction unit, and an adaptive loop filter (ALF).

The deblocking filter may remove block distortion that occurs due to a boundary between blocks in a reconstructed picture. In order to determine whether or not to perform deblocking, whether or not to apply the deblocking filter to the current block may be determined based on pixels included in several columns or rows of the block. When the deblocking filter is applied to the block, a strong filter or a weak filter may be applied depending on required deblocking filtering intensity. Also, in applying the deblocking filter, when performing vertical filtering and horizontal filtering, horizontal direction filtering and vertical direction filtering may be configured to be processed in parallel.

The offset correction module may correct an offset from the original image on a per-pixel basis with respect to the image subjected to deblocking. In order to perform offset correction for a specific picture, it is possible to use a method of separating pixels included in the image into a predetermined number of regions, determining a region to be subjected to offset, and applying the offset to the region or a method of applying an offset in consideration of edge information of each pixel.

Adaptive loop filtering (ALF) may be performed based on a value that is obtained by comparing a filtered reconstructed image and the original image. After pixels included in the image are divided into predetermined groups, a filter to be applied to each of the groups may be determined so that filtering may be differentially performed on each group. Information on whether or not to apply ALF and a luma signal may be transmitted for each coding unit (CU), and the form and filter coefficient of a filter for ALF to be applied may vary according to each block. Also, the filter for ALF with a same form (fixed form) may be applied regardless of the characteristic of an application target block.

The memory 112 may store a reconstructed block or picture calculated through the filter unit 111, and the reconstructed block or picture thus stored may be provided to the prediction units 102 and 103 in performing inter prediction.

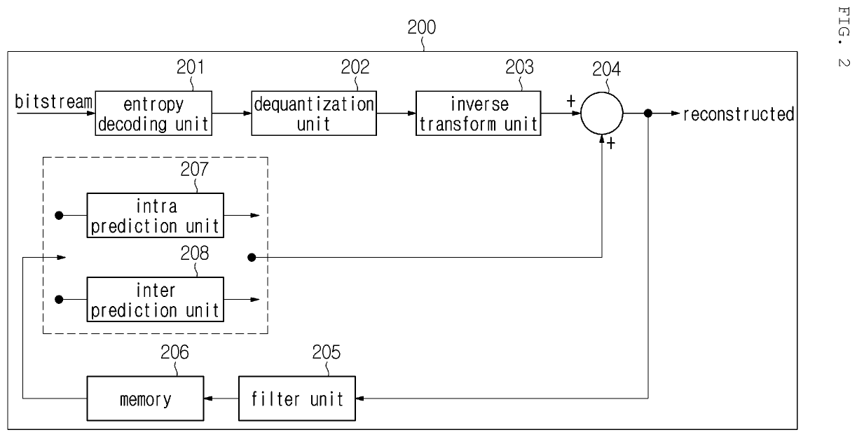

Next, an image decoding apparatus according to an embodiment of the present invention will be described with reference to a drawing. FIG. 2 is a block diagram showing an image decoding apparatus 200 according to an embodiment of the present invention.

Referring to FIG. 2, the image decoding apparatus 200 may include an entropy decoding unit 201, a dequantization unit 202, an inverse transform unit 203, an adder 204, a filter unit 205, a memory 206, and prediction units 207 and 208.

When an image bitstream generated by the image encoding apparatus 100 is input into the image decoding apparatus 200, the input bitstream may be decoded according to a reverse process to a process performed by the image encoding apparatus 100.

The entropy decoding unit 201 may perform entropy decoding in a reverse process to the entropy encoding performed in the entropy encoding unit 107 of the image encoding apparatus 100. For example, corresponding to the methods performed by the image encoding apparatus, various methods, such as exponential Golomb, context-adaptive variable length coding (CAVLC) and context-adaptive binary arithmetic coding (CABAC), may be applied. The entropy decoding unit 201 may decode the above-described syntax elements such as Last_sig, Coded_sub_blk_flag, Sig_coeff_flag, Abs_greater1_flag, Abs_greater2_flag, Sign_flag, and remaining_coeff. Also, the entropy decoding unit 201 may decode information on intra prediction and inter prediction that are performed in the image encoding apparatus 100.

The dequantization unit 202 generates a transform block by performing dequantization on a quantized transform block. It actually operates in the same manner as the Sign flag dequantization unit 108 of FIG. 1.

The inverse transform unit 203 generates a residual block by performing inverse transform on a transform block. Herein, the transform method may be determined based on information on a prediction method (inter or intra prediction), a size and/or shape of block, an intra prediction mode and the like. It actually operates in the same manner as the Sign flag inverse transform unit 109 of FIG. 1.

The adder 204 generates a reconstructed block by adding a prediction block, which is generated in the intra prediction unit 207 or the inter prediction unit 208, and a residual block generated through the inverse transform unit 203. It actually operates in the same manner as the Sign flag adder 110 of FIG. 1.

The filter unit 205 reduces various kinds of noises occurring to reconstructed blocks.

The filter unit 205 may include a deblocking filter, an offset correction unit, and an ALF.

From the image encoding apparatus 100, information on whether or not the deblocking filter is applied to a corresponding block or picture and, when the deblocking filter is applied, information on whether or not a strong filter or a weak filter is applied may be received. The deblocking filter of the image decoding apparatus 200 may receive information on the deblocking filter from the image encoding apparatus 100, and the image decoding apparatus 200 may perform deblocking filtering for a corresponding block.

The offset correction unit may perform offset correction on a reconstructed image based on a type of offset correction, offset value information, and the like, which are applied to an image during encoding.

The ALF may be applied to a coding unit based on information on whether or not to apply the ALF, ALF coefficient information and the like, which are received from the image encoding apparatus 100. Such ALF information may be provided by being included in a specific parameter set. The filter unit 205 actually operates in the same manner as the filter unit 111 of FIG. 1.

The memory 206 stores a reconstructed block that is generated by the adder 204. It actually operates in the same manner as the Sign flag memory 112 of FIG. 1.

The prediction units 207 and 208 may generate a prediction block based on information associated with prediction block generation, which is received from the entropy decoding unit 201, and information on a previously decoded block or picture that is received from the memory 206.

The prediction units 207 and 208 may include an intra prediction unit 207 and an inter prediction unit 208. Although not separately illustrated, the prediction units 207 and 208 may further include a prediction unit discrimination unit. The prediction unit discrimination unit may receive various input information, such as prediction unit information, prediction mode information of an intra prediction method, motion prediction-related information of an inter prediction method, from the entropy decoding unit 201, may distinguish a prediction unit in a current coding unit, and may discriminate whether the prediction unit performs inter prediction or intra prediction. Using information necessary for inter prediction in a current prediction unit, which is received from the image encoding apparatus 100, the inter prediction unit 208 may perform inter prediction for the current prediction unit based on information included in at least one of a preceding picture and a subsequent picture of a current picture in which the current prediction unit is included. Alternatively, the inter prediction may be performed based on information of some reconstructed regions in the current picture in which the current prediction unit is included.

In order to perform inter prediction, it may be determined which of a skip mode, a merge mode, and an AMVP mode is used as the motion prediction method of the prediction unit included in the coding unit, on the basis of the coding unit.

The intra prediction unit 207 generates a prediction block using pixels that are located around a block to be currently encoded and are already reconstructed.

The intra prediction unit 207 may include an adaptive intra smoothing (AIS) filter, a reference pixel interpolation unit, and a DC filter. The AIS filter, which is a filter performing filtering on a reference pixel of a current block, may adaptively determine whether or not to apply the filter according to a prediction mode of a current prediction unit. AIS filtering may be performed on a reference pixel of a current block by using a prediction mode of a prediction unit, which is provided by the image encoding apparatus 100, and AIS filter information. When the prediction mode of the current block is a mode in which AIS filtering is not performed, the AIS filter may not be applied.

The reference pixel interpolation unit of the intra prediction unit 207 may interpolate a reference pixel and thus generate a reference pixel at a position in fractional units, when a prediction mode of a prediction unit is a prediction unit in which intra prediction is performed based on a pixel value that is obtained by interpolating the reference pixel. The reference pixel generated at the position in fractional units may be used as a prediction pixel for pixels in the current block. When a prediction mode of a current prediction unit is not a prediction mode that generates a prediction block without interpolating a reference pixel, the reference pixel may not be interpolated. When a prediction mode of a current block is a DC mode, the DC filter may generate a prediction block through filtering.

The intra prediction unit 207 operates actually in the same manner as the intra prediction unit 102 of FIG. 1.

The inter prediction unit 208 generates an inter prediction block using motion information and a reference picture stored in the memory 206. The inter prediction unit 208 operates actually in the same manner as the inter prediction unit 103 of FIG. 1.

Hereinafter, various embodiments of the present invention will be described in further detail with reference to the accompanying drawings.

The present specification proposes a method for efficiently encoding/decoding prediction mode information of a current block.

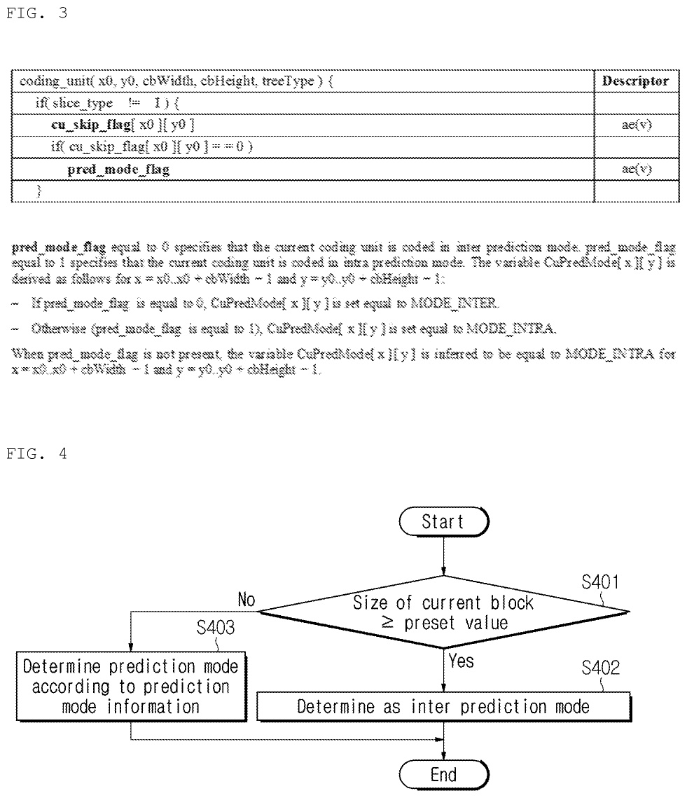

FIG. 3 is syntax and semantics for describing decoding of prediction mode information.

Referring to FIG. 3, when a current slice is not an I-slice (slice_type !=I) and a current coding unit (CU) is not a skip mode (cu_skip_flag[x0][y0]==0), prediction mode information (pred_mode_flag) may be entropy-decoded.

Herein, when the prediction mode information (pred_mode_flag) has a value of 0, it may mean an inter prediction mode (MODE_INTER). When the prediction mode information (pred_mode_flag) has a value of 1, it may mean an intraprediction mode (MODE_INTRA). In addition, when there is no prediction mode information (pred_mode_flag), it may be considered as an intra prediction mode (MODE_INTRA).

A method for encoding/decoding prediction mode information according to an embodiment of the present invention may be determined based on a size of a current block. Herein, the size of the current block may mean at least one of the width, height and area of the current block.

There is a statistical characteristic that the probability of performing inter prediction rather than intra prediction increases along with an increase in the size of a current block. In consideration of the characteristic, a prediction mode of the current block may be determined based on the size of the current block.

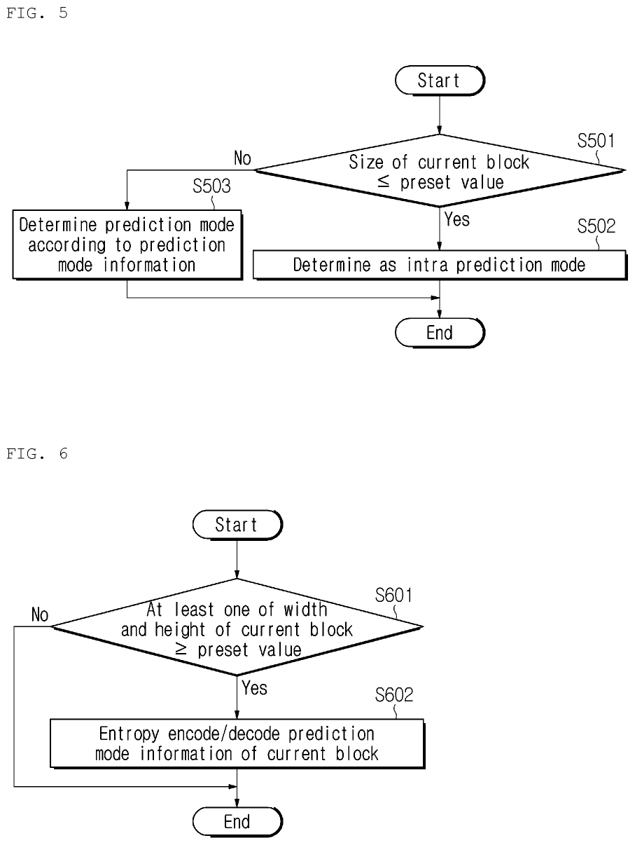

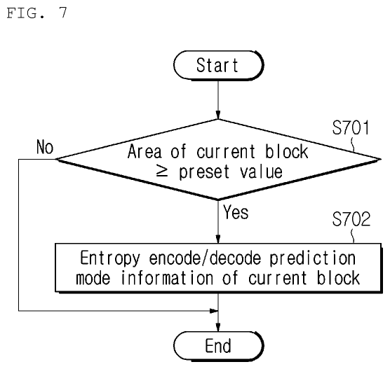

FIG. 4 and FIG. 5 are flowcharts showing a method of determining a prediction mode of a current block based on a size of the current block.

Referring to FIG. 4, when a size of a current block is equal to or greater than a preset value (S401: Yes), a prediction mode of the current block may be determined to be an inter prediction mode (S402). However, when the size of the current block is less than the preset value (S401: No), the prediction mode of the current block may be determined according to prediction mode information obtained from a bitstream (S402).

That is, in FIG. 4, when the size of the current block is equal to or greater than the preset value (S401: Yes), the prediction mode of the current block may be implicitly determined to be inter prediction without obtaining prediction mode information.

In FIG. 5, unlike the example of FIG. 4, when a size of a current block is equal to or less than a predetermined value (S501: Yes), a prediction mode of the current block may be determined to be an intra prediction mode (S502). However, when the size of the current block is greater than a preset value (S501: No), the prediction mode of the current block may be determined according to prediction mode information obtained from a bitstream (S503).

That is, in FIG. 5, when the size of the current block is equal to or less than the preset value (S501: Yes), the prediction mode of the current block may be implicitly determined to be intra prediction without obtaining prediction mode information.

Meanwhile, the preset value in FIG. 5 may be a minimum size of coding block. That is, when the size of a current block is the minimum size of a coding block, a prediction mode of the current block may be implicitly determined to be intra prediction without obtaining prediction mode information. Herein, the coding block may be a coding unit, and the minimum size of the coding block may be 4×4. As an example, when the size of a current block is 4×4, a prediction mode of the current block may be implicitly determined to be intra prediction without obtaining prediction mode information. On the contrary, when the size of a current block is not 4×4, a prediction mode of the current block may be determined according to prediction mode information obtained from a bitstream.

That is, when either the width or height of a current block is less than a preset value, prediction mode information may not be entropy-decoded, and a prediction mode of the current block may be implicitly determined to be intra prediction.

Table 1 below is an embodiment in which an entropy decoding method for prediction mode information is applied based on the above-described size of current block.

TABLE 1

Descriptor

coding_unit(x0,y0,cbWidth,cbHeight,treeType) {

if( slice_type != I ) {

| | |
|---|---|
| cu_skip_flag[x0][y0] | ae(v) |
| If( cu_skip_flag[x0][y0] == 0 && !(cbWidth = = 4 | |

&& cbHeight = = 4) )

| | |
|---|---|
| pred_mode_flag | ae(v) |

}

In Table 1, when the size of a current block is not 4×4, prediction mode information may be entropy-decoded. Otherwise, the prediction mode information may not be entropy-decoded. That is, when the width and height of a current block are a preset value, prediction mode information is not entropy-decoded, and a prediction mode of the current block may be implicitly determined to be intra prediction.

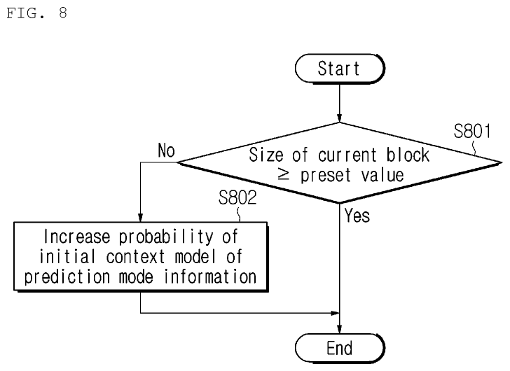

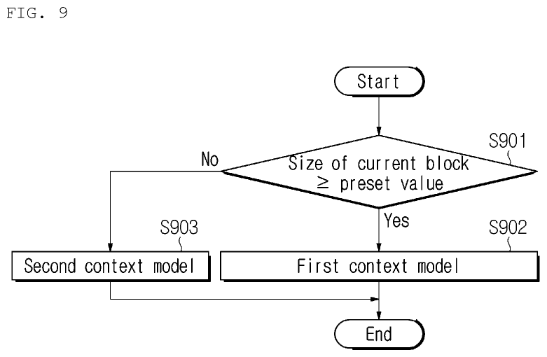

FIG. 6 and FIG. 7 are flowcharts showing an entropy encoding/decoding method of prediction mode information based on a size of a current block. As described in FIG. 3, when prediction mode information has a value of 0, it means an inter prediction mode (MODE_INTER). When prediction mode information has a value of 1, it means an intra prediction mode (MODE_INTRA). When there is no prediction mode information, it is considered as an intra prediction mode (MODE_INTRA). Under this assumption, FIG. 6 and FIG. 7 will be described.

Referring to FIG. 6, when at least one of the width and height of a current block is equal to or greater than a preset value (S601: Yes), prediction mode information of the current block may be entropy-encoded/decoded (S602).

However, when at least one of the width and height of the current block is less than the preset value (S601: No), prediction mode information of the current block is not entropy-encoded/decoded and thus the prediction mode information of the current block may be considered as an intra prediction mode.

Table 2 below is an embodiment in which an entropy decoding method for prediction mode information is applied based on the size of a current block described in FIG. 6.

TABLE 2

Descriptor

coding_unit(x0,y0,cbWidth,cbHeight,treeType) {

if( slice_type != I ) {

| | |
|---|---|
| cu_skip_flag[x0][ y0] | ae(v) |
| if( cu_skip_flag[x0][y0] == 0 && (cbWidth≥64 \|\| | |

cbHeight ≥64) )

| | |
|---|---|
| pred_mode_flag | ae(v) |

}

In Table 2, when the width or height of a current block is equal to or greater than a preset value (64), prediction mode information may be entropy-decoded. Otherwise, the prediction mode information may not be entropy-decoded.

That is, when the width and height of a current block are less than the preset value, prediction mode information is not entropy-decoded, and a prediction mode of the current block may be implicitly determined to be intra prediction.

Table 3 below is another embodiment in which an entropy decoding method for prediction mode information is applied based on the size of a current block.

TABLE 3

Descriptor

coding_unit(x0, y0, cbWidth, cbHeight, treeType) {

if( slice_type != I ) {

| | |
|---|---|
| cu_skip_flag[x0][y0] | ae(v) |
| if( cu_skip_flag[x0][y0] == 0 && cbWidth≥128 | |

&& cbHeight ≥128 )

| | |
|---|---|
| pred_mode_flag | ae(v) |

}

In Table 3, when the width and height of a current block are equal to or greater than a preset value (128), prediction mode information may be entropy-decoded. Otherwise, the prediction mode information may not be entropy-decoded.

That is, when either the width or height of a current block is less than a preset value, prediction mode information may not be entropy-decoded, and a prediction mode of the current block may be implicitly determined to be intra prediction.

Referring to FIG. 7, when the area of a current block is equal to or greater than a preset value (S701: Yes), a prediction mode of the current block may be entropy-encoded/decoded (S702).

However, when the area of the current block is less than the preset value (S701: No), prediction mode information of the current block is not entropy-encoded/decoded and thus the prediction mode information of the current block may be considered as an intra prediction mode.

Table 4 below is an embodiment in which an entropy decoding method for prediction mode information is applied based on the size of the current block described in FIG. 7.

TABLE 4

Descriptor

coding_unit(0, y0, cbWidth, cbHeight, treeType) {

if( slice_type != I ) {

| | |
|---|---|
| cu_skip_flag[x0][ y0] | ae(v) |
| if( cu_skip_flag[x0][ y0] == 0 && cbWidth * | |

cbHeight ≥ 8192 )

| | |
|---|---|
| pred_mode_flag | ae(v) |

}

In Table 4, when the area of a current block is equal to or greater than a preset value (8192), prediction mode information may be entropy-decoded. Otherwise, the prediction mode information may not be entropy-decoded.

That is, when either the width or height of a current block is less than a preset value, prediction mode information may not be entropy-decoded, and a prediction mode of the current block may be implicitly determined to be intra prediction.

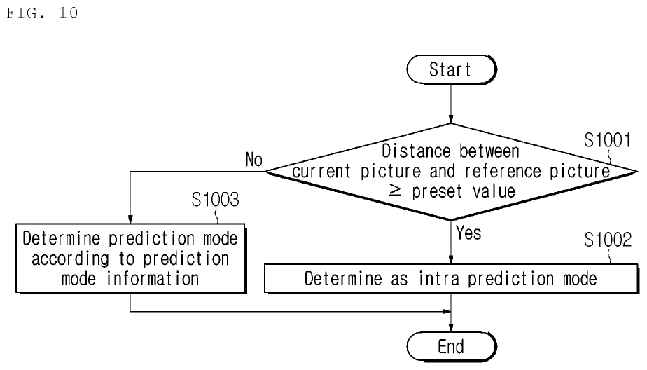

FIG. 8 is a flowchart showing an entropy encoding/decoding method of prediction mode information based on a size of a current block. Herein, the prediction mode information is entropy-encoded/decoded by context adaptive binary arithmetic coding (CABAC), and one context model may be used.

Referring to FIG. 8, when the size of a current block is less than a preset value (S801: Yes), a probability of an initial context model of prediction mode information may be increased (S802).

In the step S802, the probability of the initial context model may be increased by a predefined value.

Alternatively, in the step S802, the probability of the initial context model may be increased in inverse proportion to the size of the current block. Alternatively, the probability of the initial context model may be decreased in proportion to the size of the current block.

That is, as a probability of performing intra prediction tends to increase along with a decrease in the size of the current block, a probability that prediction mode information has a value of 1 (that is, intra prediction) may increase along with the decrease in the size of the current block, and a probability that prediction mode information has a value of 0 (that is, inter prediction) may increase along with an increase in the size of the current block.

Meanwhile, in the entropy decoding method of prediction mode information, only the step S802 of FIG. 8 may be implemented without the step S801. Specifically, without comparing the size of the current block with the preset value, it is possible to increase the probability of the initial context model of prediction mode information in inverse proportion to the size of the current block.

FIG. 9 is a flowchart showing an entropy encoding/decoding method of prediction mode information based on a size of a current block.

Instead of increasing a probability of an initial context model of prediction mode information as shown in FIG. 8, FIG. 9 proposes a method of selecting and using a new context model. Specifically, the entropy encoding/decoding method of prediction mode information in FIG. 9 may use two or more independent context models.

Referring to FIG. 9, when a size of a current block is equal to or greater than a preset value (S901: Yes), entropy encoding/decoding of prediction mode information may be performed using a first context model (S902). On the other hand, when the size of the current block is less than the preset value (S901: No), entropy encoding/decoding of prediction mode information may be performed using a second context model (S903).

Herein, the second context model may be a context model that has a higher probability of having a prediction mode information value of 1 (that is, intra prediction) than the first context model.

A method for encoding/decoding prediction mode information according to an embodiment of the present invention may be determined based on a distance between a current picture and a reference picture.

Herein, the distance between a current picture and a reference picture (delta_poc) may be derived through Equation 1 and Equation 2 below. delta_poc may be defined as a smallest value among distance differences (absolute differences) between a picture order count (POC) of a current picture and POCs of reference pictures.

$$\begin{matrix}delta\_poc = abs ( currPoc - refpoc ( l 0 , 0 ) ) & [ Equation 1 ] \\ delta\_poc = {min}_{l ∈ \{ L 0 , L 1 \} , i ∈ ref \_ list ( l )} abs ( cussPoc - refpoc ( l , i ) ) & [ Equation 2 ]\end{matrix}$$

In Equation 1 and Equation 2, abs( ) is a function for obtaining an absolute value, currPoc is a POC of a current picture, and refpoc (l, i) may denote a POC of a picture having i-th reference index of reference list 1. In addition, ref_list(l) may denote an index set of mode reference pictures existing in reference list l.

Meanwhile, there is a statistical characteristic that the probability of performing intra prediction rather than inter prediction increases along with an increase in a distance between a current picture and a reference picture. In consideration of this characteristic, it is possible to determine a prediction mode of a current block based on a distance between a current picture and a reference picture.

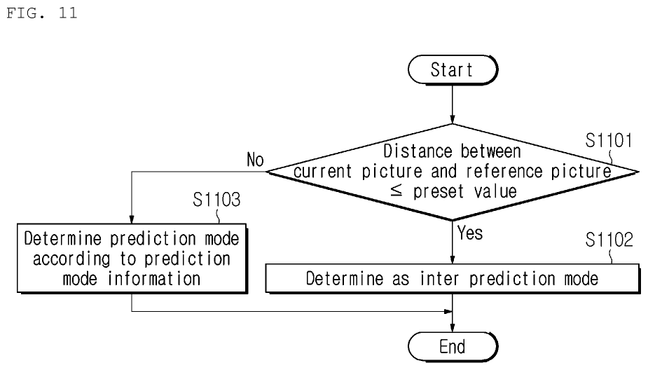

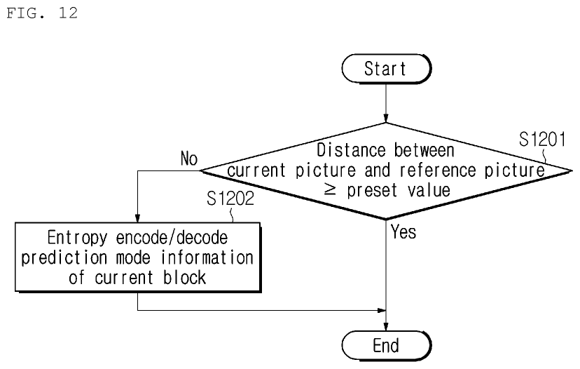

FIG. 10 and FIG. 11 are flowcharts showing a method of determining a prediction mode of a current block based on a distance between a current picture and a reference picture.

Referring to FIG. 10, when a distance between a current picture and a reference picture is equal to or greater than a preset value (S1001: Yes), a prediction mode of a current block may be determined to be an intra prediction mode (S1002). On the other hand, when the distance between the current picture and the reference picture is less than the preset value (S1001: No), the prediction mode of the current block may be determined according to prediction mode information obtained from a bitstream (S1003).

That is, in FIG. 10, when the distance between the current picture and the reference picture is equal to or greater than the preset value (S1001: Yes), the prediction mode of the current block may be implicitly determined to be intra prediction without obtaining prediction mode information.

In FIG. 11, unlike the example of FIG. 10, when a distance between a current picture and a reference picture is equal to or less than a predetermined value (S1101: Yes), a prediction mode of a current block may be determined to be an inter prediction mode (S1102). On the other hand, when the distance between the current picture and the reference picture is greater than a preset value (S1101: No), the prediction mode of the current block may be determined according to prediction mode information obtained from a bitstream (S1103).

That is, in FIG. 11, when the distance between the current picture and the reference picture is equal to or less than the preset value (S1101: Yes), the prediction mode of the current block may be implicitly determined to be inter prediction without obtaining prediction mode information.

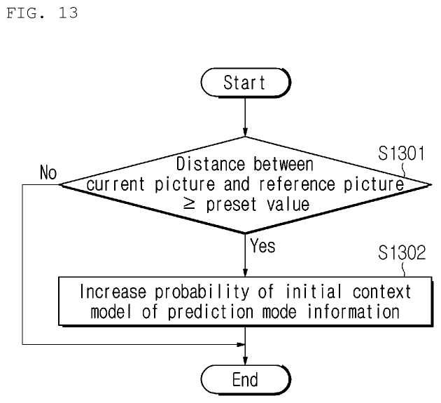

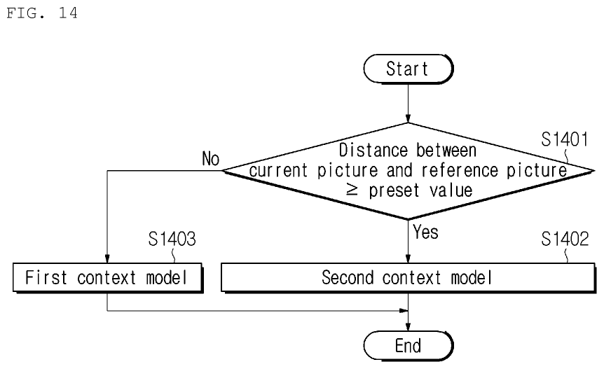

FIG. 12 and FIG. 13 are flowcharts showing an entropy encoding/decoding method of prediction mode information based on a distance between a current picture and a reference picture. As described in FIG. 3, when prediction mode information has a value of 0, it means an inter prediction mode (MODE_INTER). When prediction mode information has a value of 1, it means an intra prediction mode (MODE_INTRA). When there is no prediction mode information, it is considered as an intra prediction mode (MODE_INTRA). Under this assumption, FIG. 12 will be described.

Referring to FIG. 12, when a distance between a current picture and a reference picture is less than a preset value (S1201: No), prediction mode information of a current block may be entropy-encoded/decoded (S1202).

However, when the distance between the current picture and the reference picture is equal to or greater than the preset value (S1201: Yes), prediction mode information of the current block is not entropy-encoded/decoded and thus the prediction mode information of the current block may be considered as an intra prediction mode.

Referring to FIG. 13, when a distance between a current picture and a reference picture is equal to or greater than a preset value (S1301: Yes), it is possible to increase a probability of an initial context model of prediction mode information (S1302). In the step S1302, the probability of the initial context model may be increased by a predefined value.

Alternatively, in the step S1302, the probability of the initial context model may be increased in proportion to the relist distance between the current picture and the reference picture.

That is, as a probability of performing intra prediction tends to increase along with an increase in the distance between the current picture and the reference picture, a probability that prediction mode information has a value of 1 (that is, intra prediction) may increase along with the increase in the distance between the current picture and the reference picture, and a probability that prediction mode information has a value of 0 (that is, inter prediction) may increase along with a decrease in the distance between the current picture and the reference picture.

Meanwhile, in an entropy encoding/decoding method of prediction mode information, only the step S1302 of FIG. 13 may be implemented without the step S1301. Specifically, without comparing the preset value with the distance between the current picture and the reference picture, it is possible to increase the probability of the initial context model of prediction mode information in proportion to the distance between the current picture and the reference picture.

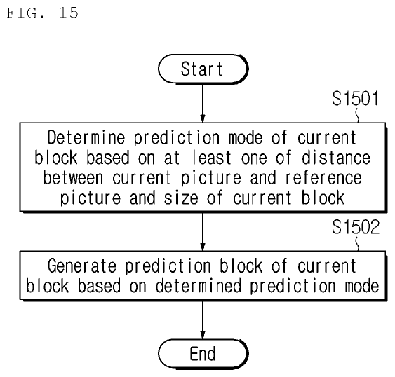

FIG. 14 is a flowchart showing an entropy encoding/decoding method of prediction mode information based on a distance between a current picture and a reference picture.

Instead of increasing a probability of an initial context model of prediction mode information as shown in FIG. 13, FIG. 14 proposes a method of selecting and using a new context model. Specifically, the entropy encoding/decoding method of prediction mode information in FIG. 14 may use two or more independent context models.

Referring to FIG. 14, when a distance between a current picture and a reference picture is equal to or greater than a preset value (S1401: Yes), entropy encoding/decoding of prediction mode information may be performed using a second context model (S1402). On the other hand, when the distance between the current picture and the reference picture is less than the preset value (S1401: No), entropy encoding/decoding of prediction mode information may be performed using a first context model (S1403).

Herein, the second context model may be a context model that has a higher probability of having a prediction mode information value of 1 (that is, intra prediction) than the first context model.

Meanwhile, an encoding/decoding method of prediction mode information may be determined by considering both a size of a current block and a distance between a current picture and a reference picture.

As an example, when the size of the current block is equal to or less than a first threshold value and the distance between the current picture and the reference picture is equal to or greater than a second threshold value, prediction mode information of the current block may not be entropy-encoded/decoded. In this case, since the prediction mode information of the current block is not entropy-encoded/decoded, the prediction mode information of the current block may be considered as an intra prediction mode.

Meanwhile, the descriptions in Table 1 to Table 4, FIG. 6 and FIGS. 7 to 12 assumed that an intra prediction mode is considered when there is no prediction mode information. However, as described in FIG. 3, an intra prediction mode may not be considered whenever there is no prediction mode information. That is, when slice_type is I-Slice, a prediction mode may be considered as intra prediction. When slice_type is not I-Slice and cu_skip_flag is 1, the prediction mode may be considered as inter prediction. Otherwise (that is, when slice_type is not I-Slice and cu_skip_flag is 0), the prediction mode may be considered as inter prediction.

Table 5 below is an embodiment in which an entropy decoding method for prediction mode information is applied based on a size of a current block under the above assumption (that is, when pred_mode_flag is not signaled, inter prediction is considered).

TABLE 5

Descriptor

coding_unit(x0,y0,cbWidth,cbHeight,treeType) {

if( slice_type != I ) {

| | |
|---|---|
| cu_skip_flag[x0][y0] | ae(v) |
| if( cu_skip_flag[x0][y0] == 0 && (cbWidth<64 \|\| | |

cbHeight <64) )

| | |
|---|---|
| pred_mode_flag | ae(v) |

}

In Table 5, when the width or height of a current block is less than a preset value (64), prediction mode information may be entropy-decoded. Otherwise, the prediction mode information may not be entropy-decoded.

That is, when the width and height of a current block are equal to or greater than the preset value, prediction mode information is not entropy-decoded, and a prediction mode of the current block may be implicitly determined to be inter prediction.

Table 6 below is another embodiment in which an entropy decoding method for prediction mode information is applied based on a size of a current block under the above assumption (that is, when pred_mode_flag is not signaled, inter prediction is considered).

TABLE 6

Descriptor

coding_unit(x0,y0,cbWidth,cbHeight,treeType) {

if( slice_type != I ) {

| | |
|---|---|
| cu_skip_flag[x0][y0] | ae(v) |
| if( cu_skip_flag[x0][y0] == 0 && (cbWidth<128 | |

&& cbHeight <128) )

| | |
|---|---|
| pred_mode_flag | ae(v) |

}

In Table 6, when the width and height of a current block are less than a preset value (128), prediction mode information may be entropy-decoded. Otherwise, the prediction mode information may not be entropy-decoded.

That is, when the width or height of a current block are equal to or greater than a preset value, prediction mode information is not entropy-decoded, and a prediction mode of the current block may be implicitly determined to be inter prediction.

Table 7 below is an embodiment in which an entropy decoding method for prediction mode information is applied based on a size of a current block under the above assumption (that is, when pred_mode_flag is not signaled, inter prediction is considered).

TABLE 7

Descriptor

coding_unit(x0,y0,cbWidth,cbHeight,treeType) {

if( slice_type != I ) {

| | |
|---|---|
| cu_skip_flag[x0][y0] | ae(v) |
| if( cu_skip_flag[x0][y0] == 0 && (cbWidth * | |

cbHeight < 8192) )

| | |
|---|---|
| pred_mode_flag | ae(v) |

}

In Table 7, when the area of a current block is less than a preset value (8192), prediction mode information may be entropy-decoded. Otherwise, the prediction mode information may not be entropy-decoded.

That is, when the area of a current block is equal to or greater than a preset value, prediction mode information is not entropy-decoded, and a prediction mode of the current block may be implicitly determined to be inter prediction.

As described in Table 4 to Table 7, when the size of a current block is equal to or greater than a preset value, prediction mode information (pred_mode_flag) may not be encoded/decoded, and a prediction mode of the current block may be considered as inter prediction.

When the above assumption (that is, when pred_mode_flag is not signaled, inter prediction is considered) is made, a condition may be changed in FIG. 6, FIG. 7 and FIG. 12. That is, in FIG. 6, the condition may be changed so that when at least one of the width and height of a current block is equal to or greater than a preset value (S601: Yes), prediction mode information (pred_mode_flag) is not entropy-encoded/decoded, and only in the opposite case (S601: No), the prediction mode information (pred_mode_flag) is entropy-encoded/decoded (S602). Similarly, in FIG. 7, the condition may be changed so that when the area of a current block is equal to or greater than a preset value (S701: Yes), prediction mode information (pred_mode_flag) is not entropy-encoded/decoded, and only in the opposite case (S701: No), the prediction mode information (pred_mode_flag) is entropy-encoded/decoded (S702). Also, similarly, in FIG. 12, the condition may be changed so that when the distance between a current picture and a reference picture is equal to or greater than a preset value (S1201: Yes), prediction mode information (pred_mode_flag) is entropy-encoded/decoded (S1202), and only in the opposite case (S1201: No), the prediction mode information (pred_mode_flag) is not entropy-encoded/decoded.

Meanwhile, the embodiments described in FIGS. 4 to 16 may be implemented in the image encoding apparatus 100 and the image decoding apparatus 200.

However, the order of applying the embodiments may be different in the image encoding apparatus 100 and the image decoding apparatus 200, and the order of applying the embodiments may be the same in the image encoding apparatus 100 and the image decoding apparatus 200.

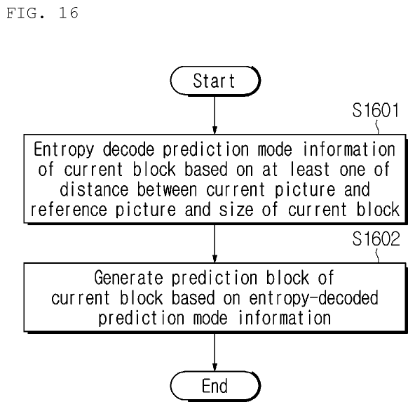

FIG. 15 is a flowchart for explaining an image decoding method according to an embodiment of the present invention.

Referring to FIG. 15, an image decoding apparatus may determine a prediction mode of a current block based on at least one of a distance between a current picture and a reference picture and a size of the current block.

In addition, the image decoding apparatus may generate a prediction block of the current block based on the determined prediction mode (S1502).

Herein, the determining of the prediction mode of the current block (S1501) may determine the prediction mode of the current block as an inter prediction mode without entropy-decoding of prediction mode information of the current block, when the size of the current block is equal to or greater than a preset value. In addition, when the size of the current block is less than the preset value, the prediction mode of the current block may be determined according to the prediction mode information of the current block.

Meanwhile, the determining of the prediction mode of the current block (S1501) may determine the prediction mode of the current block as an intra prediction mode without entropy-decoding of prediction mode information of the current block, when the size of the current block is less than a preset value. In addition, when the size of the current block is equal to or greater than the preset value, the prediction mode of the current block may be determined according to the prediction mode information of the current block.

Herein, the size of the current block may be at least one of the width, height and area of the current block.

Meanwhile, the determining of the prediction mode of the current block (S1501) may determine the prediction mode of the current block as an intra prediction mode without entropy-decoding of prediction mode information of the current block, when the distance between a current picture and a reference picture is equal to or greater than a preset value. In addition, when the distance between the current picture and the reference picture is less than the preset value, the prediction mode of the current block may be determined according to the prediction mode information of the current block.

Meanwhile, the determining of the prediction mode of the current block (S1501) may determine the prediction mode of the current block as an inter prediction mode without entropy-decoding of prediction mode information of the current block, when the distance between a current picture and a reference picture is less than a preset value. In addition, when the distance between the current picture and the reference picture is equal to or greater than the preset value, the prediction mode of the current block may be determined according to the prediction mode information of the current block.

Herein, the distance between the current picture and the reference picture may be a smallest value among distance differences between a picture order count (POC) of the current picture and POCs of reference pictures of the current block.

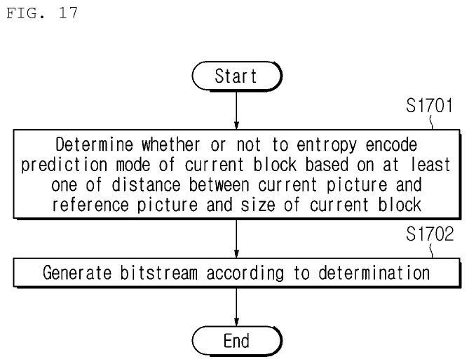

FIG. 16 is a flowchart for explaining an image decoding method according to an embodiment of the present invention.

Referring to FIG. 16, an image decoding apparatus may entropy decode prediction mode information of a current block based on at least one of a distance between a current picture and a reference picture and a size of the current block (S1601).

In addition, the image decoding apparatus may generate a prediction block of the current block based on the entropy-decoded prediction mode information (S1602).

Herein, the entropy decoding of the prediction mode information of the current block (S1601) may include, when the size of the current block is less than a preset value, increasing a probability of an initial context model for the prediction mode information of the current block, and entropy decoding the prediction mode information of the current block by using the initial context model.

Meanwhile, the entropy decoding of the prediction mode information of the current block (S1601) may include: when the size of the current block is equal to or greater than a preset value, determining a context model of the prediction mode information of the current block as a first context model; when the size of the current block is less than the preset value, determining a context model of the prediction mode information of the current block as a second context model; and entropy decoding the prediction mode information of the current block by using a determined context model. Herein, the second context model may be a context model that has a higher probability of having a prediction mode information value indicating an intra prediction mode than the first context model.

Meanwhile, the entropy decoding of the prediction mode information of the current block (S1601) may include, when the distance between the current picture and the reference picture is equal to or greater than a preset value, increasing a probability of an initial context model for the prediction mode information of the current block, and entropy decoding the prediction mode information of the current block by using the initial context model.

Meanwhile, the entropy decoding of the prediction mode information of the current block (S1601) may include: when the distance between the current picture and the reference picture is equal to or greater than a preset value, determining a context model of the prediction mode information of the current block as a second context model; when the size of the current block is less than a preset value, determining a context model of the prediction mode information of the current block as a first context model; and entropy decoding the prediction mode information of the current block by using a determined context model. Herein, the second context model may be a context model that has a higher probability of having a prediction mode information value indicating an intra prediction mode than the first context model.

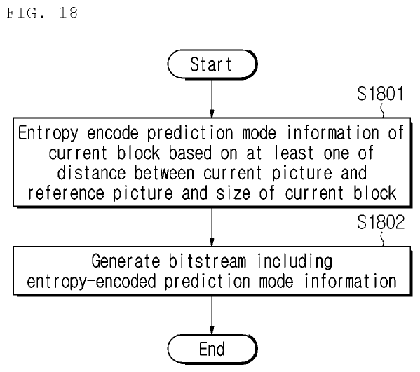

FIG. 17 is a flowchart for explaining an image encoding method according to an embodiment of the present invention.

Referring to FIG. 17, an image encoding apparatus may determine whether or not to entropy encode prediction mode information of a current block based on at least one of a distance between a current picture and a reference picture and a size of the current block (S1701). As the determining of whether or not to encode the prediction mode information based on at least one of the distance between the current picture and the reference picture and the size of the current block was described in detail in FIG. 6, FIG. 7 and FIG. 12, redundant description will be omitted.

In addition, the image encoding apparatus may generate a bitstream according to the determination (S1702). Specifically, when it is determined that entropy encoding of prediction mode information of a current block is not performed, the image encoding apparatus may generate a bitstream that does not include the prediction mode information of the current block.

FIG. 18 is a flowchart for explaining an image encoding method according to an embodiment of the present invention.

Referring to FIG. 18, an image encoding apparatus may entropy encode prediction mode information of a current block based on at least one of a distance between a current picture and a reference picture and a size of the current block (S1801). As the entropy encoding of the prediction mode information of the current block based on at least one of the distance between the current picture and the reference picture and the size of the current block was described in detail in FIG. 8, FIG. 9, FIG. 13 and FIG. 14, redundant description will be omitted.

In addition, the image encoding apparatus may generate a bitstream including the entropy-encoded prediction mode information (S1802).

Although the exemplary methods of the present disclosure are represented by a series of acts for clarity of explanation, they are not intended to limit the order in which the steps are performed, and if necessary, each step may be performed simultaneously or in a different order. In order to implement a method according to the present disclosure, the illustrative steps may include an additional step or exclude some steps while including the remaining steps. Alternatively, some steps may be excluded while additional steps are included.

The various embodiments of the present disclosure are not intended to be all-inclusive and are intended to illustrate representative aspects of the disclosure, and the features described in the various embodiments may be applied independently or in a combination of two or more.

In addition, the various embodiments of the present disclosure may be implemented by hardware, firmware, software, ora combination thereof. In the case of hardware implementation, one or more application specific integrated circuits (ASICs), digital signal processors (DSPs), digital signal processing devices (DSPDs), programmable logic devices (PLDs), field programmable gate arrays A general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer.

### INDUSTRIAL APPLICABILITY

The present invention may be used for an apparatus for encoding/decoding an image.

1. An image decoding method, the method comprising:
determining a prediction mode of a current block based on a size of the current block; and
generating a prediction block of the current block based on the determined prediction mode,
wherein the determining of the prediction mode of the current block determines the prediction mode of the current block based on a comparison result between the size of the current block and a preset value.

2. The image decoding method of claim 1, wherein the determining of the prediction mode of the current block determines the prediction mode of the current block as an intra prediction mode without entropy-decoding of prediction mode information of the current block, when the size of the current block is equal to or less than the preset value.

3. The image decoding method of claim 1, wherein the determining of the prediction mode of the current block entropy-decodes prediction mode information of the current block, when the size of the current block is greater than the preset value, and determines the prediction mode of the current block according to the entropy-decoded prediction mode information of the current block.

4. The image decoding method of claim 1, wherein the determining of the prediction mode of the current block determines the prediction mode of the current block as an intra prediction mode without entropy-decoding of prediction mode information of the current block, when the size of the current block is equal to the preset value.

5. The image decoding method of claim 1, wherein the size of the current block comprises at least one of a width and a height of the current block.

6. An image encoding method, the method comprising:
determining a prediction mode of a current block based on a size of the current block; and
generating a bitstream according to the determination,
wherein the determining of the prediction mode of the current block determines whether or not to entropy-encode prediction mode information based on a comparison result between a size of the current block and a preset value.

7. A non-transitory computer-readable recording medium comprising a bitstream used for image decoding, wherein the bitstream comprises prediction mode information of a current block,
wherein, in the image decoding, a prediction mode of the current block is determined based on a comparison result between a size of the current block and a preset value, and
wherein, when the size of the current block is equal to the preset value, the prediction mode of the current block is determined to be an intra prediction mode without entropy-decoding of the prediction mode information of the current block.
